(19) United States
(12) Patent Application Publication
(10) Pub. No.: US 2008/0075913 A1
(43) Pub. Date: Mar. 27, 2008

(54) Reinforced wallboard

(76) Inventor: Leonard Frenkil, Baltimore, MD (US)

Correspondence Address: BIRCH STEWART KOLASCH & BIRCH, PO BOX 747, FALLS CHURCH, VA, 22040-0747, US

(21) Appl. No.: 11/526,758

(22) Filed: Sep. 26, 2006

(51) Int. Cl. B32B 21/06; B32B 29/00

(52) U.S. Cl. 428/76; 428/537.5; 428/535; 428/220

(57) ABSTRACT

A reinforced wallboard that has improved core strength and is designed to facilitate the secure attachment of cabinets and/or other heavy objects to the surface thereof. Generally the reinforced wallboard includes a structural substrate having an upper surface and a lower surface, a first binding layer bonded to the upper surface, and a first paper layer bonded to the binding layer. The structural substrate layer may be formed of plywood wood, or other suitable materials, such as melamine. The wallboard may have one or more tapered edges so that the tapered edges and paper layer give the appearance of ordinary gypsum plaster wallboard and allow for its installation with standard wallboard fasteners, spackling, tools, and techniques.

### BACKGROUND OF THE INVENTION

1. Field of the Invention

The present invention is directed generally to wallboards and more particularly to wallboards that are reinforced to provide better support for structures mounted thereto.

2. Description of Related Art

Standard paper-wrapped wallboard with a gypsum plaster-filled structural substrate core is conventionally used today in the construction of most residential and commercial buildings. However, these wallboards with a plaster structural substrate generally are not strong enough by themselves to support most cabinetry or other fixtures mounted thereon. Typically the wallboard requires special devices or supplemental construction to distribute the weight from such cabinetry or fixtures to both the wallboard and studs to which the wallboard is mounted. In addition, many fixtures or decorations including, shelving, mirrors, picture frames, and wall hangings require special anchors to distribute the weight of the decoration to the surrounding area of the wallboard.

The present invention represents an improvement over such standard plaster structural substrate wallboards by providing a reinforced wallboard that eliminates the need for locating studs, special devices, or supplemental construction to support cabinetry and/or other fixtures.

### BRIEF SUMMARY OF THE INVENTION

According to an exemplary embodiment of the invention, a wallboard is provided that includes a nonplaster structural substrate layer having an upper surface and a lower surface, a first binding layer bonded to the upper surface, and a first paper layer bonded to the binding layer. The structural substrate layer is preferably formed from plywood, but may also be formed of wood or a synthetic material such as melamine.

In a further aspect of the invention, the wallboard may have one or more tapered edges so that the tapered edges and paper layer yield the appearance of ordinary gypsum wallboard and allow for its installation with standard wallboard fasteners, spackling, paint, tools, and techniques.

Preferably, the wallboard's upper surface and bonded paper is of such consistency as to provide a stable planar surface and also allows for the countersinking and subsequent spackling of the required mounting wallboard screws and nails.

The wallboard is configured to provide a structural substrate, integral to the wallboard that will allow fasteners for the cabinetry or other devices to engage and be supported by the integral structure. Therefore, the cabinetry or other devices can be attached without reference to studs, supplemental construction, or special anchors. In addition, the strengthened structural substrate causes the wallboard to resist any moment arms force created by the mounting of cabinetry or other devices.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a perspective view of a wallboard according to a first exemplary embodiment of the invention;

FIG. 2 is a cross-sectional view of the wallboard of FIG. 1;

FIG. 3 is a cross-sectional view of a second exemplary embodiment of the invention; and

FIG. 4 is a plan view of a third exemplary embodiment of the invention.

### DETAILED DESCRIPTION OF THE INVENTION

Generally the present invention relates to a paper covered wall panel or wallboard structure having improved core structural substrate strength and is designed to facilitate the secure attachment of cabinets and/or other heavy objects to the surface thereof. The present invention allows for the elimination of pre-installation blocking strips, nailers, and other special fasteners by more evenly distributing the weight of a heavy object, such as a cabinet, hung or attached to a wall surface comprised of one or more of the reinforced wallboards.

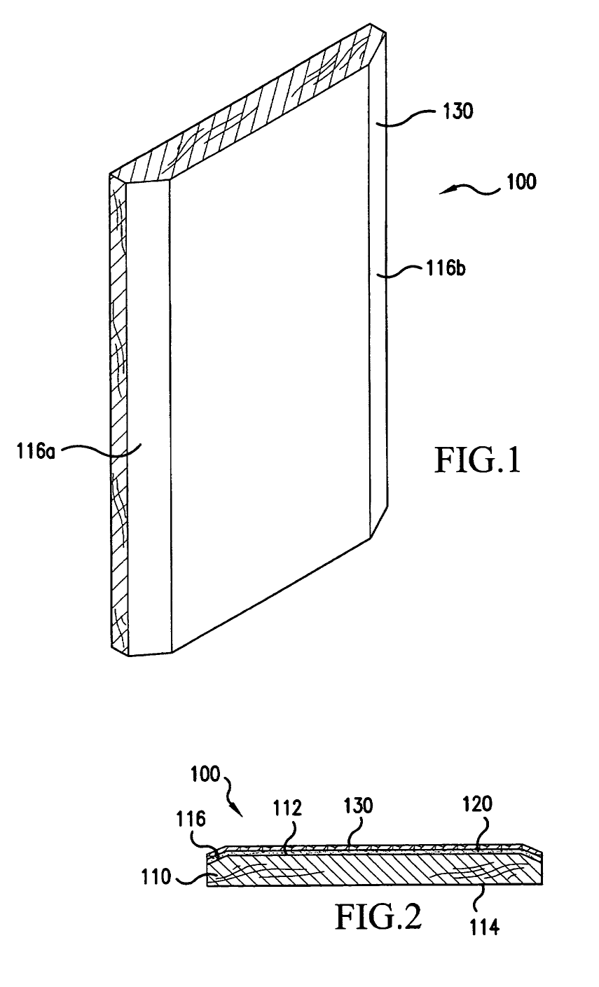

Referring to FIGS. 1 and 2, there is shown a perspective view of a wallboard 100 according to a first exemplary embodiment of the invention. The wallboard 100 includes a nonplaster structural substrate 110 having an upper surface 112 and a lower surface 114, a first binding layer 120 bonded to the upper surface 112, and a first paper layer 130 bonded to the first binding layer 120.

The structural substrate 110 is preferably formed of plywood, but other materials such as melamine or other nonplaster structural substrates may be used. The thickness of the structural substrate 110 may be selected such that the combination of the structural substrate 110, binding layer 120, and first paper layer provides a nominal thickness of a range of a half-inch, five-eighths of an inch, as well as other standard wallboard thicknesses. The wallboard 100 may be provided in standard four foot by eight-foot lengths, ten-foot lengths, or other nonstandard lengths.

The structural substrate 110 may also include one or more tapered or beveled edges, but preferably at least one pair of tapered edges 116a, 116b. The pair of tapered edges 116a, 116b gives wallboard 100 a similar appearance and application of standard wallboards. As such, the pair of tapered edges 116a, 116b allows the wallboard 100 to be mounted and spackled in place of standard wallboards using standard installation techniques and materials.

If the structural substrate 110 is formed of wood or lower grade plywood, the first binding layer 120 may have a predetermined consistency to accommodate imperfections in the upper surface 112 of the structural 110. In this manner, where necessary, the first binding layer 120 can provide a substantially planar surface and the first paper layer 130 can also have a smooth appearance. The binding layer may include adhesive, filler, and/or a combination of adhesive and filler. Depending on the smoothness of the upper surface, the appropriate application of adhesive to filler can be adjusted to provide a suitable consistency for the binding layer. Alternatively, a structural substrate 110 having a smooth upper surface 112 (e.g., plywood grade A or B) or a wood layer that has been smoothed using conventional means may be used.

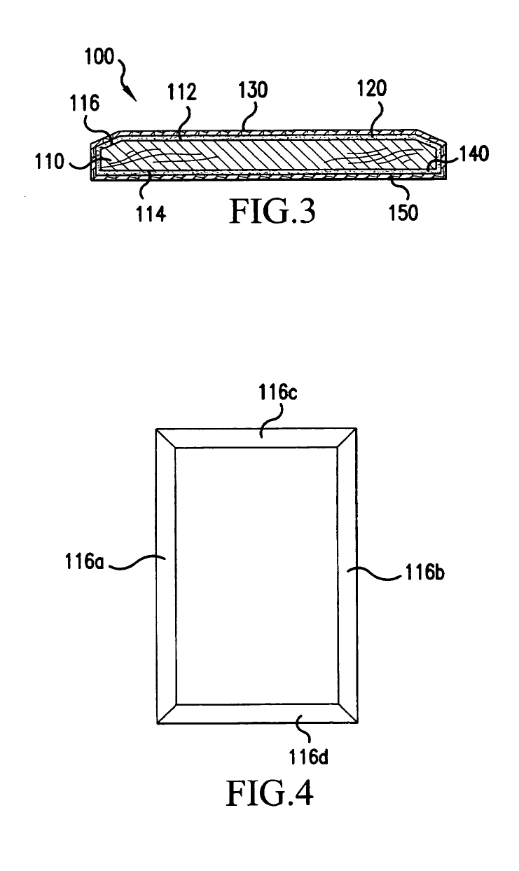

If desired, wallboard 100, as shown in FIG. 3, may include a second binding layer 140 bonded to the lower surface 114 and a second paper layer 150 bonded to the second binding layer 140. The second binding layer 140 may be similar to the first binding layer 120 so that the second binding layer 140 also has a substantially planar surface. Alternatively, the second paper layer 150 may have a different surface color, texture, and/or appearance than the first paper layer 130 which would also aid in identifying which side of the wallboard 100 should be oriented away from the studs or other wall framing as well as providing an alternate total planar surface.

One exemplary method of forming wallboard 100 would include providing a structural substrate 110 made of wood, such as plywood. The upper surface 112 may be sanded to provide a smoother surface or left untreated. By smoothing the upper surface 112, less binding material may be used to provide a planar surface for attaching the first paper layer 130. However, if left untreated, then the binding layer may be of a predetermined consistency to penetrate imperfections in the structural substrate surface as well as to bond with the paper. The pair of tapered edges 116a, 116b may also be formed at this time. As noted above, structural substrate 110 may have a pre-formed smooth upper surface 112, thereby requiring a thinner binding layer.

Next, the first binding layer 120 is applied using conventional means, such as, for example, sprayers, brushes, or rollers. As discussed above, the first binding layer 120 may be an adhesive, such as epoxy or glue, which is suitable for attaching the paper layer 130 to the structural substrate 110. The first binding layer 120 may be applied to either the first paper layer 130 or to the structural substrate 110. If applied to the structural substrate 110, a skimmer may be used to cause the binding material to fill in the imperfections of the upper surface 112, if necessary, and provide a planar surface.

Finally, the first paper layer 130 is bonded to the structural substrate 110 via the first binding layer 120 using conventional means, such as, pressing or rolling. As noted above, if the first binding layer 120 is applied to the first paper layer 130, then the first binding layer 120 may be bonded to the structural substrate 110 by a rolling or pressing operation that will allow the binding material to penetrate the imperfections, if any, and provide a planar surface. Similarly, for the second embodiment of FIG. 3, the second paper layer 150 and second binding layer 140 may be provided as described for the first paper layer 130 and first binding layer 120.

In a third exemplary embodiment, as seen in FIG. 4, the wallboard 100 may include one or more tapered edges 116a, 116b, 116c, and 116d. The wallboard may otherwise be constructed as having one paper layer or two paper layers as described above. One advantage of providing tapered edges on more than two sides of the wallboard is the flexibility in orienting the wallboard 100 in many different orientations. This flexibility in orienting the wallboard allows for more efficient use of the wallboard material.

The exemplary embodiment of a reinforced wallboard described above provides an advantage over existing wallboards by making the wallboards stronger, more utilitarian, and easier to install eliminating the need for pre-installation preparation of blocking strips, nailers, and/or other special fasteners.

In addition, wallboard 100 is of such strength that it resists moment arms created by the weight of cabinetry or other devices mounted thereto. As a result, the cabinetry or other devices are less likely to pull free from the wall.

The invention thus being described, it will be obvious that the same may be varied in many ways. For example, there are many different processing techniques that can be used to assemble the various layers of the reinforced wallboards. Such variations are not to be regarded as a departure from the spirit and scope of the invention, and all such modifications as would be obvious to one skilled in the art are intended to be included within the scope of the following claims.

What is claimed:

1. A wallboard comprising:
a nonplaster structural substrate having an upper surface and a lower surface;
a first binding layer bonded to the upper surface; and
a first paper layer bonded to the binding layer.

2. The wallboard according to claim 1, wherein the structural substrate comprises plywood.

3. The wallboard according to claim 1, wherein the structural substrate includes one or more tapered edges.

4. The wallboard according to claim 1, wherein the structural substrate includes a pair of tapered edges on opposite edges of the structural substrate.

5. The wallboard according to claim 1, wherein more than two edges of the structural substrate have tapered edges.

6. The wallboard according to claim 1, wherein the first binding layer includes an adhesive.

7. The wallboard according to claim 1, wherein the first binding layer includes filler.

8. The wallboard according to claim 1, wherein the thickness of the wallboard is selected to approximate standard gypsum plaster wallboard thicknesses.

9. The wallboard according to claim 1, wherein the thickness of the wallboard is selected from one of approximately a half-inch thick and five-eighths thick.

10. The wallboard according to claim 1, further comprising:
a second binding layer bonded to the lower surface; and
a second paper layer bonded to the second binding layer.

11. The wallboard according to claim 10, wherein the first paper layer has a different surface and appearance than the second paper layer.

12. The wallboard according to claim 1, wherein the first binding layer has a consistency suitable for accommodating imperfections in the upper surface of the structural substrate to provide a planar surface.

13. The wallboard according to claim 1, wherein the structural substrate comprises a synthetic material.

14. The wallboard according to claim 13, wherein the synthetic material is melamine.
